(19) United States
(12) Patent Application Publication
(10) Pub. No.: US 2024/0220370 A1
(43) Pub. Date: Jul. 4, 2024

(54) IMPLEMENTING NATIVE SNAPSHOTTING FOR REDO-LOG FORMAT SNAPSHOTS

(71) Applicant: VMware, Inc., Palo Alto, CA (US)

(72) Inventors: Zhen LIU, Shanghai (CN); Tao XIE, Shanghai (CN); Banghui LUO, Shanghai (CN); Enning XIANG, San Jose, CA (US); Yang Yang ZHANG, Shanghai (CN)

(21) Appl. No.: 18/147,061

(22) Filed: Dec. 28, 2022

(51) Int. Cl. G06F 11/14

(52) U.S. Cl. CPC G06F 11/1451; G06F 11/1435; G06F 11/1464; G06F 2201/845

(57) ABSTRACT

A method for implementing native snapshot capabilities on non-native snapshots includes generating a virtual disk container having both native snapshot functionality and functionality of the non-native snapshot, including redo-log snapshot functionality. Redo-log parent disk chains may be preserved, along with subsequent native snapshot data, in virtual disk container objects. A virtual root node of a copy-on-write data structure of a virtual disk container object enables snapshotting and traversal between a redo-log disk chain and a native snapshot disk chain. Throughout backup and reversion operations, the virtual disk container object may be reparented as necessary, and a constant running point may be maintained for the virtual disk container object.

### BACKGROUND

In the field of data storage, a storage area network (SAN) is a dedicated, independent high-speed network that interconnects and delivers shared pools of storage devices to multiple servers. A virtual SAN, or VSAN is a logical partition in a physical SAN. One such storage virtualization system which may aggregate local or direct-attached data storage devices to create a single storage pool shared across all hosts in a host cluster is the VMware® vSAN storage virtualization system. The pool of storage of a VSAN (sometimes referred to herein as a “datastore” or “data storage”) may allow virtual machines (VMs) running on hosts in the host cluster to store virtual disks that are accessed by the VMs during their operations. A VSAN architecture may be a two-tier datastore including a performance tier for the purpose of read caching and write buffering and a capacity tier for persistent storage.

Data blocks in general may be located in storage containers known as virtual disk containers. Such virtual disk containers are a part of a logical storage fabric and are a logical unit of underlying hardware. Typically, virtual volumes can be grouped based on management and administrative needs. For example, one virtual disk container can contain all virtual volumes needed for a particular deployment. Virtual disk containers serve as virtual volume store and virtual disk volumes are allocated out of the container capacity.

A VSAN datastore may manage storage of virtual disks at a block granularity. For example, a VSAN may be divided into a number of physical blocks (e.g., 4096 bytes or “4K” size blocks), each physical block having a corresponding physical block address (PBA) that indexes the physical block in storage. Physical blocks of the VSAN may be used to store blocks of data (also referred to as data blocks) used by VMs, which may be referenced by logical block addresses (LBAs).

The VSAN datastore architecture may enable snapshot features for backup, archival, or data protections purposes. Snapshots provide the ability to capture a point-in-time state and data of a VM to not only allow data to be recovered in the event of failure but restored to known working points. Snapshots may not be stored as physical copies of all data blocks, but rather may entirely or in part be stored as pointers to the data blocks that existed when the snapshot was created. Each snapshot may include its own logical map (interchangeably referred to herein as a “snapshot logical map”) storing its snapshot metadata, e.g., a mapping of LBAs to PBAs, or its own logical map and middle map storing its snapshot metadata, e.g., mapping of LBAs to middle block addresses (MBAs) which are further mapped to PBAs, stored concurrently by several compute nodes (e.g., metadata servers). Where a logical map has not been updated from the time a first snapshot was taken to a time a subsequent snapshot was taken, snapshot logical maps may include identical mapping information for the same LBA (e.g., mapped to the same MBA and PBA). In other words, data blocks may be either owned by a snapshot or shared with a subsequent snapshot (e.g., created later in time).

Durability can be achieved through the use of transaction journaling. In particular, transaction journaling provides the capability to prevent permanent data loss following a system failure. A transaction journal, also referred to as a log, is a copy of database updates in a chronological order. In the event of such a failure, the transaction journal may be replayed to restore the database to a usable state. Transaction journaling preserves the integrity of the database by ensuring that logically related updates are applied to the database in their entirety or not at all.

For example, “redo-log” format snapshotting is a snapshotting approach that uses a transaction journaling approach. Redo-log may be used with the virtual machine file system (VMFS), and was used primarily with earlier versions of VSAN using VSAN on-disk format v1. Snapshots taken using this approach may be referred to as a redo-log snapshot or a redo-log format snapshot. When a redo-log snapshot is made for a base disk, a new delta disk object is created. The parent is considered a “point-in-time” (PIT) copy, and new writes will be written to the delta disk, while other read requests may go to a parent or an ancestor in a chain of base disks and delta disks. One disadvantage of redo-log format snapshotting is that the running point may change frequently between virtual disks. Further, as incremental snapshots are generated, the system resource consumption increases linearly for opening or reading the disk.

Another approach to snapshotting is the native snapshot approach, which is enabled for VSAN on-disk format v2 and higher. In contrast to creating a new object (the delta disk) to accept new writes, native snapshot technology takes a snapshot on a container internal to the virtual disk, and all metadata and data are maintained internally within the contained entity. As compared to redo-log snapshotting, native snapshotting may organize the data in a way that is more efficient and easier to manage and access. Specifically, the order of complexity to locate, open and read data may be reduced from O(n²) to O(n(log(n))) or possibly O(n) in some cases. Another advantage of native snapshotting may be a constant running point or less frequent changing of the running point, such that new writes are written to the same virtual disk.

Several snapshot formats exist, as newer formats are created and become more widely adopted. Examples include VMware® Virtual Volumes (vVols), VSANSparse (which uses in-memory metadata cache and a sparse filesystem layout), SEsparse (which is similar to VMFSsparse, or redo-log format), and others. vVols can enable offloading of data services such as snapshot and close operations to a storage array and support for other applications. In various situations, older format snapshots may need to be upgraded to support capabilities of newer format snapshots.

For environments where network attached storage devices (“NAS array[s]”) are used, “native” (sometimes referred to as “memory” or “array”) snapshotting may be used. One example of such a networked array of data storage devices is the storage array used in the VMware virtual volumes (vVols) environment. In such environments, data services such as snapshot and clone operations can be offloaded to the storage array. Being able to offload such operations provides several advantages to native snapshotting over other formats.

A snapshot may include its own snapshot metadata, e.g., mapping of LBAs mapped to PBAs, stored concurrently by several compute nodes (e.g., metadata servers). The snapshot metadata may be stored as key-value data structures to allow for scalable input/output (I/O) operations. In particular, a unified logical map B+ tree may be used to manage logical extents for the logical address to physical address mapping of each snapshot, where an extent is a specific number of contiguous data blocks allocated for storing information. A B+ tree is a multi-level data structure having a plurality of nodes, each node containing one or more key-value pairs stored as tuples (e.g., <key, value>). A key is an identifier of data and a value is either the data itself or a pointer to a location (e.g., in memory or on disk) of the data associated with the identifier.

Data blocks taken by snapshotting may be stored in data structures that increase performance, such as various copy-on-write (COW) data structures, including logical map B+ tree type data structures (also referred to as an append-only B+ trees). COW techniques (including copy-on-first-write and redirect-on-write techniques) improve performance and provide time and space efficient snapshot creation by only copying metadata about a node where the original data is stored, as opposed to creating a physical copy of the data, when a snapshot is created. When a COW approach is taken and a new child snapshot is to be created, instead of copying the entire logical map B+ tree of the parent snapshot, the child snapshot shares with the parent, and sometimes ancestor snapshots, one or more extents, meaning one or more nodes, by having a B+ tree index node, exclusively owned by the child snapshot. The index node of the new child snapshot includes pointers (e.g., index values) to child nodes, which initially are nodes shared with the parent snapshot. For a write operation, a shared node, which is shared between the parent snapshot and the child snapshot, requested to be overwritten by the COW operation may be referred to as a source shared node. Before executing the write, the source shared node is copied to create a new node, owned by the running point (e.g., the child snapshot), and the write is then executed to the new node in the running point.

If a resource is duplicated but not modified, it is not necessary to create a new resource; the resource can be shared between the copy and the original. Modifications necessitate creating a copy, hence the technique: the copy operation is deferred until the first write. By sharing resources in this way, it is possible to significantly reduce the resource consumption of unmodified copies, while adding a small overhead to resource-modifying operations.

In the past, a redo-log approach to snapshotting was used instead of a native format approach. However, converting a disk chain having different types of VSAN objects as members to a disk chain where each object is of the same type can cause interruption in VM services.

It may therefore be desirable to enable native snapshotting for a redo-log format disk chain or disk chain family, without interruption, failure, data loss, or downgrading of performance. For this reason, there is a need in the art for improved techniques to enable native snapshot functionality for redo-log format snapshot disk chains.

It should be noted that the information included in the Background section herein is simply meant to provide a reference for the discussion of certain embodiments in the Detailed Description None of the information included in this Background should be considered as an admission of prior art.

### SUMMARY

Aspects of the present disclosure introduce techniques for upgrading a redo-log snapshot of a virtual disk to support native snapshot functionality or other similar functionality. According to various embodiments, a method for implementing native snapshotting for redo-log format snapshots is disclosed herein. The method includes receiving a redo-log snapshot disk of a parent disk. The redo-log snapshot disk has first snapshot data. The method also includes generating a first native snapshot of the redo-log snapshot disk. The first native snapshot has second snapshot data in a first native data structure. The method also includes generating a second native snapshot of the parent disk. The second native snapshot has third snapshot data in a second native data structure. The method also includes writing the redo-log snapshot disk, the first native snapshot, and the second native snapshot to a virtual disk container. The first snapshot data is copied into the first native data structure, and the second snapshot data is copied into the second native data structure.

According to various embodiments, a non-transitory computer-readable medium comprising instructions is disclosed herein. The instructions, when executed by one or more processors of a computing system, cause the computing system to perform operations for restoring at least one data block from a snapshot, the operations comprising: performing a revert operation on a first virtual disk container having a first snapshot; if the revert operation is a native parent revert operation, accessing a native parent of the snapshot on the first virtual disk container; and if the revert operation is a redo-log parent revert operation, traversing a portion of a redo-log parent chain on a second virtual disk container that is a redo-log parent of the first virtual disk container.

According to various embodiments, a system comprising one or more processors; and at least one memory is disclosed herein. The one or more processors and the at least one memory are configured to cause the system to: receive a redo-log snapshot disk of a parent disk. Perform a first native snapshot on the redo-log snapshot disk to generate a first native snapshot disk. Perform a second native snapshot on the parent disk to generate a second native snapshot disk. Write the redo-log snapshot disk, the first native snapshot disk, and the second native snapshot to a virtual disk container.

### BRIEF DESCRIPTION OF THE DRAWINGS

FIG. 1 is a diagram illustrating an example computing environment in which embodiments of the present application may be practiced.

FIG. 2A is a block diagram illustrating a B+ tree data structure, according to an example embodiment of the present application.

FIG. 2B is a block diagram illustrating a B+ tree data structure using a copy-on-write (COW) approach, according to an example embodiment of the present application.

FIG. 3 is a block diagram illustrating a redo-log format virtual disk chain.

FIG. 4A is a block diagram illustrating a native format virtual disk chain.

FIG. 4B is a block diagram illustrating the native format virtual disk chain of FIG. 4A after an additional native format snapshot is taken.

FIG. 5 is a block diagram illustrating a virtual disk chain having both redo-log and native format snapshots.

FIG. 6 is a block diagram illustrating a native format snapshot approach for a disk chain.

FIG. 7 is a block diagram illustrating a redo-log format snapshot approach for a disk chain.

FIG. 8 is a diagram illustrating a B+ tree data structure using a COW approach and having a virtual root node.

FIG. 9 is a block diagram illustrating a virtual disk chain having both redo-log and native format snapshots.

FIG. 10 is a block diagram illustrating a virtual disk chain having both redo-log and native format snapshots.

FIG. 11 is a flowchart illustrating a sample workflow for reversion and snapshotting of a disk chain.

### DETAILED DESCRIPTION

VSAN environments provide optimized performance for datastores containing large amounts of data. Snapshotting may be used to provide backup and durability of the data. Rather than copying an entire volume of data every time a snapshot is made, pointers to the memory location of the data may be used. Specialized data structures may be used to increase performance of VSAN environments. Arranging snapshot data and/or pointers in a logical data tree structure not only allows for relatively fast location and retrieval of the data but also enables application of COW approaches.

The way in which data is structured or organized for a redo-log disk chain and for a native format disk chain may differ. For example, a redo-log disk chain can include a chain of delta disks recording changes to a base or redo-log parent disk. A native format disk chain can include a chain of copies or clones of a base or native parent disk. In both cases, pointers to a location in which a block of data is located may be used instead of copying data.

In various cases, “redo-log snapshot” as used herein may refer to a backup for an electronic storage medium, or a technique for backing up an electronic storage medium, such that a current or past state of a storage medium can be recreated or accessed at a future or current time. Generally when a redo-log snapshot is made, the state of the virtual machine disk serving as the running point is preserved (e.g. becomes read-only). For example, a guest operating hosting such a virtual machine disk will not be able to write to the disk. This virtual machine disk can be referred to as the parent disk, or the “redo-log” parent disk. As new changes are made at the running point, the changes are stored on a new virtual disk which may be referred to as a “delta” disk or as “child disk” or “redo-log child disk.”

In some cases a redo-log snapshot can be taken when a first redo-log child disk already exists. In these cases, as new changes (e.g. write-operations) are made, the changes can be stored on a second redo-log child disk. This may be referred to as a child disk of the first redo-log child disk, or as a grandchild disk of the redo-log parent of this example. As a consequence, the first redo-log child disk may also become a parent disk (as can the second and subsequent disks). It will be understood that multiple disks having a parent-child or other relationship together may form a disk “family,” disk “ancestry,” or disk “chain.”

In various cases, “native snapshot” as used herein may also refer to a backup for an electronic storage medium, or a technique for backing up an electronic storage medium, such that a current or past state of the storage medium can be recreated or accessed at a future or current time. For native format snapshots, an exemplary base or parent disk may be a NAS array.

Virtual machine disks that are snapshots of a running point disk are created. However, the creation operations are offloaded to the NAS array, including both creating new disks and cloning virtual machine disks or data from a parent. Since these operations are offloaded to the NAS array rather than performed by a host device, the host devices experiences reduced workload and increased performance. Offloading these operations also can decrease network load between a host and the NAS array (or other storage). In such examples, networked file storage format devices in the array are able to copy or clone virtual machine disks without requiring the host to read or write the copied or cloned virtual machine disk or data.

In contrast to a redo-log format snapshot, when a native snapshot is performed, the running point does not change to a delta disk where data blocks associated with new write operations are created, such as by writing new data, new pointers to data, or updates to pointers to data. Instead, the running point for the native snapshot approach is constantly maintained at the native parent disk. In this example, native format snapshot copy and clone operations are offloaded to an array of networked storage devices and copies and/or clones of the running point are created using the offloaded operations. New write operations are accepted at the running point, which does not change. The running point is maintained since the operations associate with generating the copy or clone which serves as the backup occur at the array of networked storage devices.

The virtual disk that is the copy or clone of the running point disk may be referred to as a native format child disk, or “native child” disk of the running point disk. The running point disk in this situation may be referred to as a native format parent disk or “native parent” disk. It will be again understood that multiple disks having a parent-child or other relationship together may form a disk “family,” disk “ancestry,” or disk “chain.”

In the situation where a native snapshot is taken where a first native child disk already exists and subsequent write operations have been made to the native parent after the child disk was cloned or copied, the write operations will occur at the native parent, as the running point is maintained at the native parent. To perform the native snapshot in this case, a second native child disk is copied or cloned from the native parent using offloaded operations as previously described. The write operations occurring subsequent to the first child disk being copied or cloned will be copied or cloned are reflected in the second native child, but not the first native child. The native parent remains the running point and subsequent write operations occur at the native parent.

When reverting from a running point disk that is a native parent disk of a native child disk that is a native format snapshot of the running point disk, pointers of the native child disk may be copied to the running point disk or native parent disk. This may be known as a native parent revert operation. When reverting from a delta disk or redo-log child disk that is a redo-log format snapshot of a redo-log parent disk, pointers of the redo-log parent disk are copied to the delta disk or redo-log child disk. This may be referred to as a redo-log parent revert operation.

For a redo-log disk chain, pointers in a redo-log child disk will point to the redo-log parent disk, and pointers in a in a redo-log grandchild disk (that is a child of the redo-log child disk) may point to storage locations of the redo-log child disk. In contrast, for a native format disk chain, a native child disk will contain pointers to a native parent disk. However, a native grandchild disk will also contain pointers to the native parent disk. The native grandchild disk will not contain pointers to the native child disk. In various examples, this results in a difference between the data structure for a redo-log disk chain and the data structure for a native disk chain. This difference is accounted for by use of a virtual root node when storing the data structures.

Because of the differences in snapshotting formats between redo-log and native format snapshotting, copying the parent tree structure to a child snapshot disk can create difficulties when dealing with a disk chain that is mixed (i.e. when a disk has both redo-log and native format ancestry). Special handling may also be required in the case of reversion from a child disk to a parent disk across a disk chain that has both a redo-log and native snapshot member.

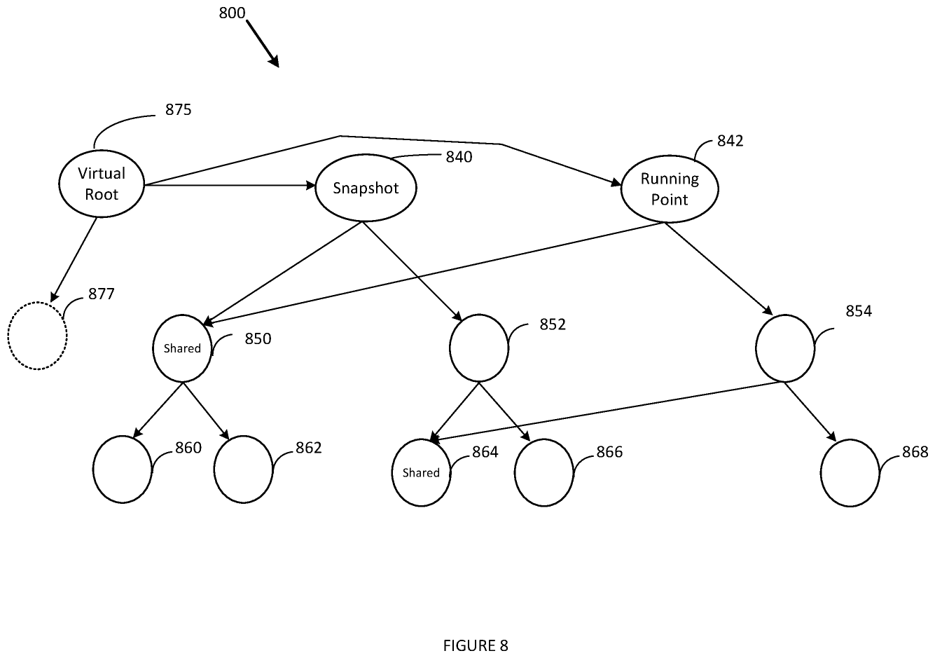

To address these issues, native format snapshots may be taken of both a parent disk and a redo-log snapshot of the parent disk, and these native format snapshots may be stored together with the redo-log snapshot of the parent disk in a single virtual disk container. In some cases, as described in more detail below with respect to FIGS. 8-12, a virtual root node is created for the data tree structure of the virtual disk container. The virtual root node serves as a logical base node for the virtual disk container (e.g., including for subsequent native snapshots) and allows the parent disk chain to be successfully traversed during reversion despite the inclusion of both redo-log and native snapshots in the chain.

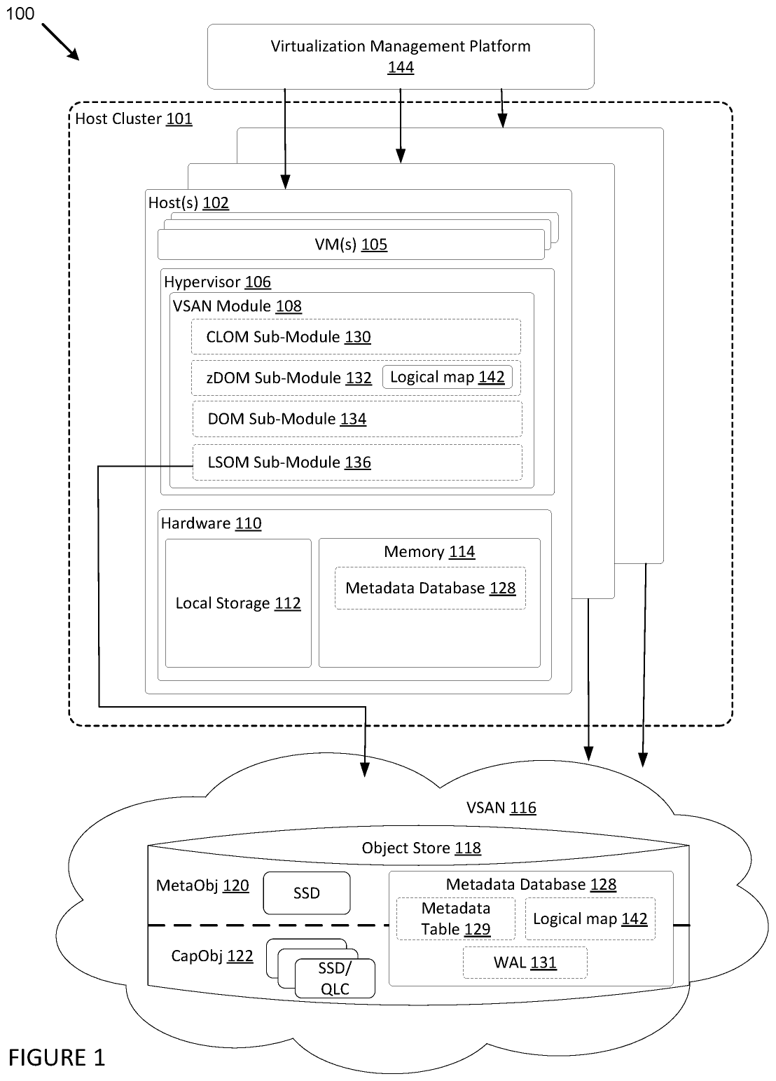

FIG. 1 is a diagram illustrating an example computing environment 100 in which embodiments may be practiced. As shown, computing environment 100 may include a distributed object-based datastore, such as a software-based “virtual storage area network” (VSAN) environment, VSAN 116, that leverages the commodity local storage housed in or directly attached (hereinafter, use of the term “housed” or “housed in” may be used to encompass both housed in or otherwise directly attached) to host(s) 102 of a host cluster 101 to provide an aggregate object storage to virtual machines (VMs) 105 running on the host(s) 102. The local commodity storage housed in the hosts 102 may include combinations of solid state drives (SSDs) or non-volatile memory express (NVMe) drives, magnetic or spinning disks or slower/cheaper SSDs, or other types of storages.

Additional details of VSAN are described in U.S. Pat. No. 10,509,708, the entire contents of which are incorporated by reference herein for all purposes, and U.S. patent application Ser. No. 17/181,476, the entire contents of which are incorporated by reference herein for all purposes.

As described herein, VSAN 116 is configured to store virtual disks of VMs 105 as data blocks in a number of physical blocks, each physical block having a PBA that indexes the physical block in storage. VSAN module 108 may create an “object” for a specified data block by backing it with physical storage resources of an object store 118 (e.g., based on a defined policy).

VSAN 116 may be a two-tier datastore, storing the data blocks in both a smaller, but faster, performance tier and a larger, but slower, capacity tier. The data in the performance tier may be stored in a first object (e.g., a data log that may also be referred to as a MetaObj 120) and when the size of data reaches a threshold, the data may be written to the capacity tier (e.g., in full stripes, as described herein) in a second object (e.g., CapObj 122) in the capacity tier. SSDs may serve as a read cache and/or write buffer in the performance tier in front of slower/cheaper SSDs (or magnetic disks) in the capacity tier to enhance I/O performance. In some embodiments, both performance and capacity tiers may leverage the same type of storage (e.g., SSDs) for storing the data and performing the read/write operations. Additionally, SSDs may include different types of SSDs that may be used in different tiers in some embodiments. For example, the data in the performance tier may be written on a single-level cell (SLC) type of SSD, while the capacity tier may use a quad-level cell (QLC) type of SSD for storing the data.

Each host 102 may include a storage management module (referred to herein as a VSAN module 108) in order to automate storage management workflows (e.g., create objects in MetaObj 120 and CapObj 122 of VSAN 116, etc.) and provide access to objects (e.g., handle I/O operations to objects in MetaObj 120 and CapObj 122 of VSAN 116, etc.) based on predefined storage policies specified for objects in object store 118.

A virtualization management platform 144 is associated with host cluster 101. Virtualization management platform 144 enables an administrator to manage the configuration and spawning of VMs 105 on various hosts 102. As illustrated in FIG. 1, each host 102 includes a virtualization layer or hypervisor 106, a VSAN module 108, and hardware 110 (which includes the storage (e.g., SSDs) of a host 102). Through hypervisor 106, a host 102 is able to launch and run multiple VMs 105. Hypervisor 106, in part, manages hardware 110 to properly allocate computing resources (e.g., processing power, random access memory (RAM), etc.) for each VM 105. Each hypervisor 106, through its corresponding VSAN module 108, provides access to storage resources located in hardware 110 (e.g., storage) for use as storage for virtual disks (or portions thereof) and other related files that may be accessed by any VM 105 residing in any of hosts 102 in host cluster 101.

VSAN module 108 may be implemented as a “VSAN” device driver within hypervisor 106. In such an embodiment, VSAN module 108 may provide access to a conceptual “VSAN” through which an administrator can create a number of top-level “device” or namespace objects that are backed by object store 118 of VSAN 116. By accessing application programming interfaces (APIs) exposed by VSAN module 108, hypervisor 106 may determine all the top-level file system objects (or other types of top-level device objects) currently residing in VSAN 116.

Each VSAN module 108 (through a cluster level object management or “CLOM” sub-module 130) may communicate with other VSAN modules 108 of other hosts 102 to create and maintain an in-memory metadata database 128 (e.g., maintained separately but in synchronized fashion in memory 114 of each host 102) that may contain metadata describing the locations, configurations, policies and relationships among the various objects stored in VSAN 116. Specifically, in-memory metadata database 128 may serve as a directory service that maintains a physical inventory of VSAN 116 environment, such as the various hosts 102, the storage resources in hosts 102 (e.g., SSD, NVMe drives, magnetic disks, etc.) housed therein, and the characteristics/capabilities thereof, the current state of hosts 102 and their corresponding storage resources, network paths among hosts 102, and the like. In-memory metadata database 128 may further provide a catalog of metadata for objects stored in MetaObj 120 and CapObj 122 of VSAN 116 (e.g., what virtual disk objects exist, what component objects belong to what virtual disk objects, which hosts 102 serve as “coordinators” or “owners” that control access to which objects, quality of service requirements for each object, object configurations, the mapping of objects to physical storage locations, etc.).

In-memory metadata database 128 is used by VSAN module 108 on host 102, for example, when a user (e.g., an administrator) first creates a virtual disk for VM 105 as well as when VM 105 is running and performing I/O operations (e.g., read or write) on the virtual disk.

In certain embodiments, in-memory metadata database 128 may include a recovery context 146. As described in more detail below, recovery context 146 may maintain a directory of one or more index values. As used herein, an index value may be recorded at a time after processing a micro-batch such that if a crash occurs during the processing of a subsequent micro-batch, determining which extents have been deleted and which extents still need to be deleted after recovering from the crash may be based on the recorded index value.

VSAN module 108, by querying its local copy of in-memory metadata database 128, may be able to identify a particular file system object (e.g., a virtual machine file system (VMFS) file system object) stored in object store 118 that may store a descriptor file for the virtual disk. The descriptor file may include a reference to a virtual disk object that is separately stored in object store 118 of VSAN 116 and conceptually represents the virtual disk (also referred to herein as composite object). The virtual disk object may store metadata describing a storage organization or configuration for the virtual disk (sometimes referred to herein as a virtual disk “blueprint”) that suits the storage requirements or service level agreements (SLAs) in a corresponding storage profile or policy (e.g., capacity, availability, IOPs, etc.) generated by a user (e.g., an administrator) when creating the virtual disk.

The metadata accessible by VSAN module 108 in in-memory metadata database 128 for each virtual disk object provides a mapping to or otherwise identifies a particular host 102 in host cluster 101 that houses the physical storage resources (e.g., slower/cheaper SSDs, magnetics disks, etc.) that actually stores the physical disk of host 102.

In certain embodiments, VSAN module 108 (and, in certain embodiments, more specifically, zDOM sub-module 132 of VSAN module 108, described in more detail below) may be configured to generate one or more snapshots created in a chain of snapshots. According to aspects described herein, z-DOM sub-module 132 may be configured to perform the deletion of one or more snapshots using micro-batch processing. As described in more detail below, to reduce transaction journaling overhead when deleting snapshots, zDOM sub-module 132 may be configured to split a batch of extents to be deleted into smaller micro-batches for deletion, where each micro-batch is configured with a threshold number of pages that can be modified. To efficiently delete such extents while adhering to the threshold number of pages limit, zDOM sub-module 132 may make use of the locality of data blocks to determine which extents may be added to each micro-batch for processing (e.g., deletion).

Various sub-modules of VSAN module 108, including, in some embodiments, CLOM sub-module 130, distributed object manager (DOM) sub-module 134, zDOM sub-module 132, and/or local storage object manager (LSOM) sub-module 136, handle different responsibilities. CLOM sub-module 130 generates virtual disk blueprints during creation of a virtual disk by a user (e.g., an administrator) and ensures that objects created for such virtual disk blueprints are configured to meet storage profile or policy requirements set by the user. In addition to being accessed during object creation (e.g., for virtual disks), CLOM sub-module 130 may also be accessed (e.g., to dynamically revise or otherwise update a virtual disk blueprint or the mappings of the virtual disk blueprint to actual physical storage in object store 118) on a change made by a user to the storage profile or policy relating to an object or when changes to the cluster or workload result in an object being out of compliance with a current storage profile or policy.

In one embodiment, if a user creates a storage profile or policy for a virtual disk object, CLOM sub-module 130 applies a variety of heuristics and/or distributed algorithms to generate a virtual disk blueprint that describes a configuration in host cluster 101 that meets or otherwise suits a storage policy. The storage policy may define attributes such as a failure tolerance, which defines the number of host and device failures that a VM can tolerate. A redundant array of inexpensive disks (RAID) configuration may be defined to achieve desired redundancy through mirroring and access performance through erasure coding (EC). EC is a method of data protection in which each copy of a virtual disk object is partitioned into stripes, expanded and encoded with redundant data pieces, and stored across different hosts 102 of VSAN 116 datastore. For example, a virtual disk blueprint may describe a RAID 1 configuration with two mirrored copies of the virtual disk (e.g., mirrors) where each are further striped in a RAID 0 configuration. Each stripe may contain a plurality of data blocks (e.g., four data blocks in a first stripe). Including RAID 5 and RAID 6 configurations, each stripe may also include one or more parity blocks. Accordingly, CLOM sub-module 130, may be responsible for generating a virtual disk blueprint describing a RAID configuration.

CLOM sub-module 130 may communicate the blueprint to its corresponding DOM sub-module 134, for example, through zDOM sub-module 132. DOM sub-module 134 may interact with objects in VSAN 116 to implement the blueprint by allocating or otherwise mapping component objects of the virtual disk object to physical storage locations within various hosts 102 of host cluster 101. DOM sub-module 134 may also access in-memory metadata database 128 to determine the hosts 102 that store the component objects of a corresponding virtual disk object and the paths by which those hosts 102 are reachable in order to satisfy the I/O operation. Some or all of metadata database 128 (e.g., the mapping of the object to physical storage locations, etc.) may be stored with the virtual disk object in object store 118.

When handling an I/O operation from VM 105, due to the hierarchical nature of virtual disk objects in certain embodiments, DOM sub-module 134 may further communicate across the network (e.g., a local area network (LAN), or a wide area network (WAN)) with a different DOM sub-module 134 in a second host 102 (or hosts 102) that serves as the coordinator for the particular virtual disk object that is stored in local storage 112 of the second host 102 (or hosts 102) and which is the portion of the virtual disk that is subject to the I/O operation. If VM 105 issuing the I/O operation resides on a host 102 that is also different from the coordinator of the virtual disk object, DOM sub-module 134 of host 102 running VM 105 may also communicate across the network (e.g., LAN or WAN) with the DOM sub-module 134 of the coordinator. DOM sub-modules 134 may also similarly communicate amongst one another during object creation (and/or modification).

Each DOM sub-module 134 may create their respective objects, allocate local storage 112 to such objects, and advertise their objects in order to update in-memory metadata database 128 with metadata regarding the object. In order to perform such operations, DOM sub-module 134 may interact with a local storage object manager (LSOM) sub-module 136 that serves as the component in VSAN module 108 that may actually drive communication with the local SSDs (and, in some cases, magnetic disks) of its host 102. In addition to allocating local storage 112 for virtual disk objects (as well as storing other metadata, such as policies and configurations for composite objects for which its node serves as coordinator, etc.), LSOM sub-module 136 may additionally monitor the flow of I/O operations to local storage 112 of its host 102, for example, to report whether a storage resource is congested.

zDOM sub-module 132 may be responsible for caching received data in the performance tier of VSAN 116 (e.g., as a virtual disk object in MetaObj 120) and writing the cached data as full stripes on one or more disks (e.g., as virtual disk objects in CapObj 122). To reduce I/O overhead during write operations to the capacity tier, zDOM may require a full stripe (also referred to herein as a full segment) before writing the data to the capacity tier. Data striping is the technique of segmenting logically sequential data, such as the virtual disk. Each stripe may contain a plurality of data blocks; thus, a full stripe write may refer to a write of data blocks that fill a whole stripe. A full stripe write operation may be more efficient compared to the partial stripe write, thereby increasing overall I/O performance. For example, zDOM sub-module 132 may do this full stripe writing to minimize a write amplification effect. Write amplification, refers to the phenomenon that occurs in, for example, SSDs, in which the amount of data written to the memory device is greater than the amount of information you requested to be stored by host 102. Write amplification may differ in different types of writes. Lower write amplification may increase performance and lifespan of an SSD.

In some embodiments, zDOM sub-module 132 performs other datastore procedures, such as data compression and hash calculation, which may result in substantial improvements, for example, in garbage collection, deduplication, snapshotting, etc. (some of which may be performed locally by LSOM sub-module 136 of FIG. 1).

In some embodiments, zDOM sub-module 132 stores and accesses an extent map 142. Extent map 142 provides a mapping of LBAs to PBAs, or LBAs to MBAs to PBAs. Each physical block having a corresponding PBA may be referenced by one or more LBAs.

In certain embodiments, for each LBA, VSAN module 108, may store in a logical map of extent map 142, at least a corresponding PBA. As mentioned previously, the logical map may store tuples of <LBA, PBA>, where the LBA is the key and the PBA is the value. In some embodiments, the logical map further includes a number of corresponding data blocks stored at a physical address that starts from the PBA (e.g., tuples of <LBA, PBA, number of blocks>, where LBA is the key). In some embodiments where the data blocks are compressed, the logical map further includes the size of each data block compressed in sectors and a compression size (e.g., tuples of <LBA, PBA, number of blocks, number of sectors, compression size>, where LBA is the key).

In certain other embodiments, for each LBA, VSAN module 108, may store in a logical map, at least a corresponding MBA, which further maps to a PBA in a middle map of extent map 142. In other words, extent map 142 may be a two-layer mapping architecture. A first map in the mapping architecture, e.g., the logical map, may include an LBA to MBA mapping table, while a second map, e.g., the middle map, may include an MBA to PBA mapping table. For example, the logical map may store tuples of <LBA, MBA>, where the LBA is the key and the MBA is the value, while the middle map may store tuples of <MBA, PBA>, where the MBA is the key and the PBA is the value.

Logical and middle maps may also be used in snapshot mapping architecture. In particular, each snapshot included in the snapshot mapping architecture may have its own snapshot logical map. Where a logical map has not been updated from the time a first snapshot was taken to a time a subsequent snapshot was taken, snapshot logical maps may include identical tuples for the same LBA. As more snapshots are accumulated over time (i.e., increasing the number of snapshot logical maps), the number of references to a same PBA extent may increase. Accordingly, numerous metadata write I/Os at the snapshot logical maps needed to update the PBA for LBA(s) of multiple snapshots (e.g., during segment cleaning) may result in poor snapshot performance at VSAN 116. For this reason, the two-layer snapshot mapping architecture, including a middle map, may be used to address the problem of I/O overhead when dynamically relocating physical data blocks.

For example, data block content referenced by a first LBA, LBA1, of three snapshots (e.g., snapshot A, B, and C) may all map to a first MBA, MBA1, which further maps to a first PBA, PBA1. If the data block content referenced by LBA1 is moved from PBA1 to another PBA, for example, PBA10, due to segment cleaning for a full stripe write, only a single extent at a middle map may be updated to reflect the change of the PBA for all of the LBAs which reference that data block. In this example, a tuple for MBA1 stored at the middle map may be updated from <MBA1, PBA1> to <MBA1, PBA10>. This two-layer snapshot extent architecture reduces I/O overhead by not requiring the system to update multiple references to the same PBA extent at different snapshot logical maps. Additionally, the two-layer snapshot extent architecture removes the need to keep another data structure to find all snapshot logical map pointers pointing to a middle map.

Embodiments herein are described with respect to the two-layer snapshot extent architecture having both a logical map and a middle map. In certain embodiments, the logical map(s) and the middle map of the two-layer snapshot extent mapping architecture are each a B+ tree. In various embodiments B+ trees are used as data structures for storing metadata.

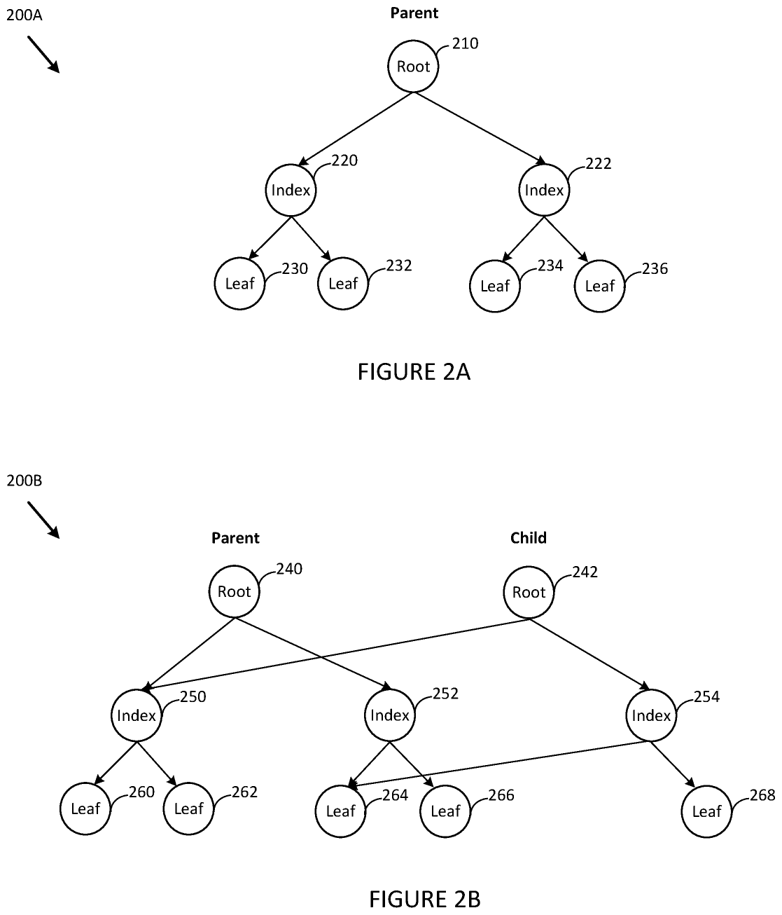

FIG. 2A is a block diagram illustrating a B+ tree 200A data structure, according to an example embodiment of the present application. As illustrated, B+ tree 200A may include a plurality of nodes connected in a branching tree structure. Each node may have one parent and two or more children. The top node of a B+ tree may be referred as root node 210, which has no parent node. The middle level of B+ tree 200A may include middle nodes 220 and 222, which may have both parent and child nodes. In the illustrated example, B+ tree 200A has only two levels, and thus only a single middle level, but other B+ trees may have more middle levels and thus greater heights. The bottom level of B+ tree 200A may include leaf nodes 230-236 which do not have any more children. In the illustrated example, in total, B+ tree 200A has seven nodes, two levels, and a height of three. Root node 210 is in level two of the tree, middle (or index) nodes 220 and 222 are in level one of the tree, and leaf nodes 230-236 are in level zero of the tree.

Each node of B+ tree 200A may store at least one tuple. In a B+ tree, leaf nodes may contain data values (or real data) and middle (or index) nodes may contain only indexing keys. For example, each of leaf nodes 230-236 may store at least one tuple that includes a key mapped to real data, or mapped to a pointer to real data, for example, stored in a memory or disk. In a case where B+ tree 200A is a logical map B+ tree, the tuples may correspond to key-value pairs of <LBA, MBA> mappings for data blocks associated with each LBA. In a case where B+ tree 200A is a middle map B+ tree, the tuples may correspond to key-value pairs of <MBA, PBA> mappings for data blocks associated with each MBA. In some embodiments, each leaf node may also include a pointer to its sibling(s), which is not shown for simplicity of description. On the other hand, a tuple in the middle nodes and/or root nodes of B+ tree 200A may store an indexing key and one or more pointers to its child node(s), which can be used to locate a given tuple that is stored in a child node.

Because B+ tree 200A contains sorted tuples, a read operation such as a scan or a query to B+ tree 200A may be completed by traversing the B+ tree relatively quickly to read the desired tuple, or the desired range of tuples, based on the corresponding key or starting key.

In certain embodiments, a B+ tree may be a copy-on-write (COW) B+ tree (also referred to as an append-only B+ tree). COW techniques improve performance and provide time and space efficient snapshot creation by only copying metadata about where the original data is stored, as opposed to creating a physical copy of the data, when a snapshot is created. Accordingly, when a COW approach is taken and a new child snapshot is to be created, instead of copying the entire logical map B+ tree of the parent snapshot, the child snapshot shares with the parent and ancestor snapshots one or more extents by having a B+ tree index node, exclusively owned by the child B+ tree, point to shared parent and/or ancestor B+ tree nodes. This COW approach for the creation of a child B+ tree may be referred to as a “lazy copy approach” as the entire logical map B+ tree of the parent snapshot is not copied when creating the child B+ tree.

FIG. 2B is a block diagram illustrating a B+ tree data structure 200B using a COW approach, according to an example embodiment of the present application. As shown in FIG. 2B, index node 250 and leaf node 264 are shared by root node 240 of a first B+ tree (e.g., a parent snapshot B+ tree) and root node 242 of a second B+ tree (e.g., a child snapshot B+ tree) generated from the first B+ tree. This way, the two root nodes 240 and 242 may share the data of the tree without having to duplicate the entire data of the tree. Further, root node 240 may exclusively own leaf node 266, while root node 242 may exclusively own leaf node 268.

In certain embodiments, the logical map(s) associated with one or more snapshots are a B+ tree using a COW approach, as illustrated in FIG. 2B, while the middle map is a regular B+ tree, as illustrated in FIG. 2A.

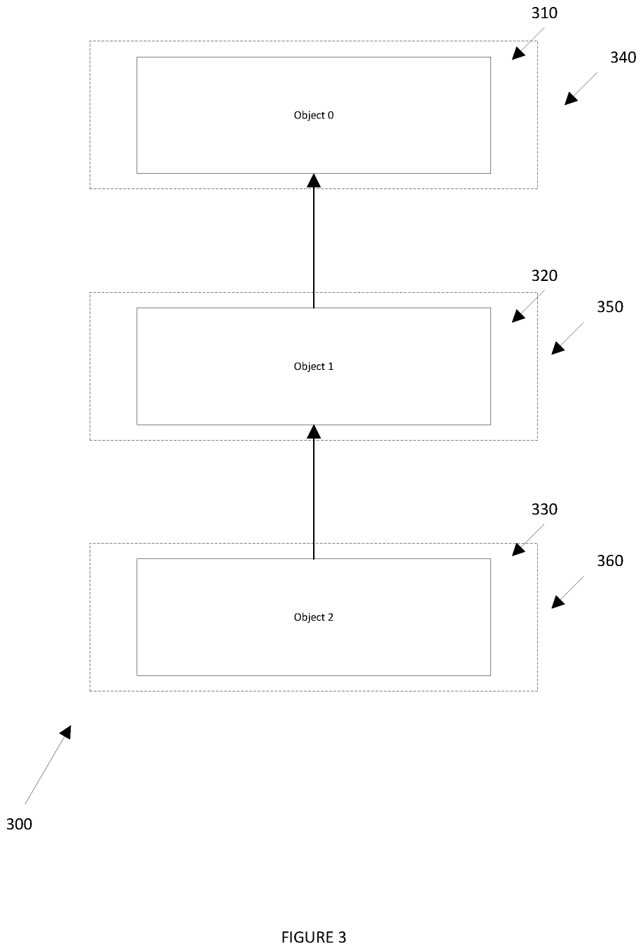

FIG. 3 is a diagram illustrating a redo-log format virtual disk chain 300 having a base virtual machine disk 310, a first delta virtual disk 320, and a second delta virtual disk 330. As shown, the base virtual disk 310 is a parent of the first delta virtual disk 320. The first delta virtual disk 320 is a parent of second delta virtual disk 330. The first delta disk 320 is created when a redo-log format snapshot of the parent disk, in this case the base virtual machine disk 310, is taken. The second delta virtual disk 330 is created when a redo-log format snapshot of the first delta virtual disk 320 is created. When a virtual machine is being executed with a running point at the second virtual disk 330, each parent virtual disk 320, 310, must be open. As shown, the base virtual disk 310 is contained in a first virtual disk object 340, the first delta virtual disk 320 is contained in a second virtual disk object 350, and the second delta virtual disk 330 is contained in a third virtual disk object 360. A virtual disk chain may have any number of member virtual disks. The running point may need to access data on different virtual disks and may therefore “swing” between disk objects. For example, by having to traverse a greater distance across a data structure or data structures. Such swinging is detrimental to performance.

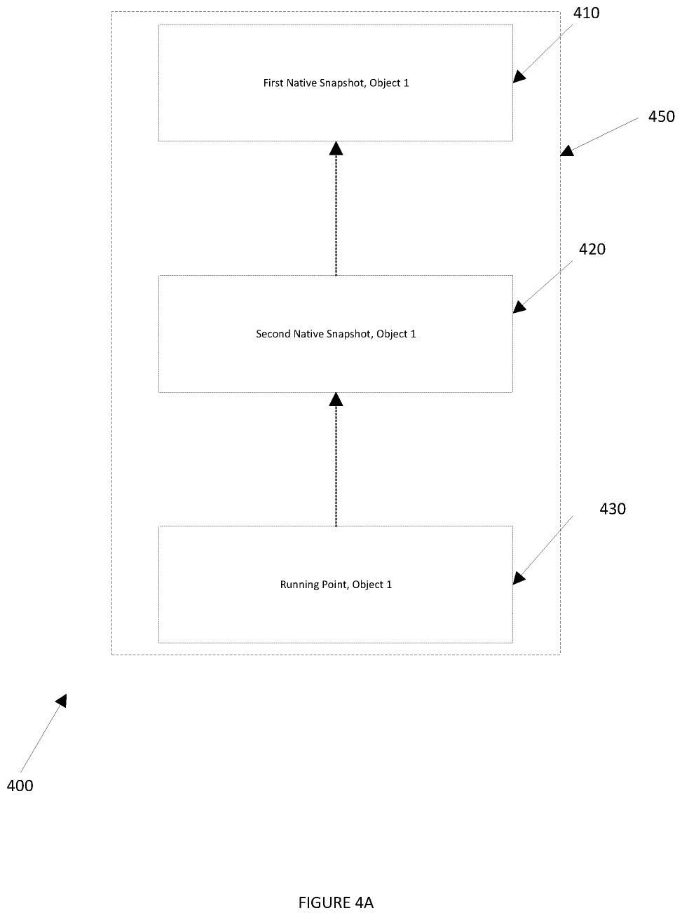

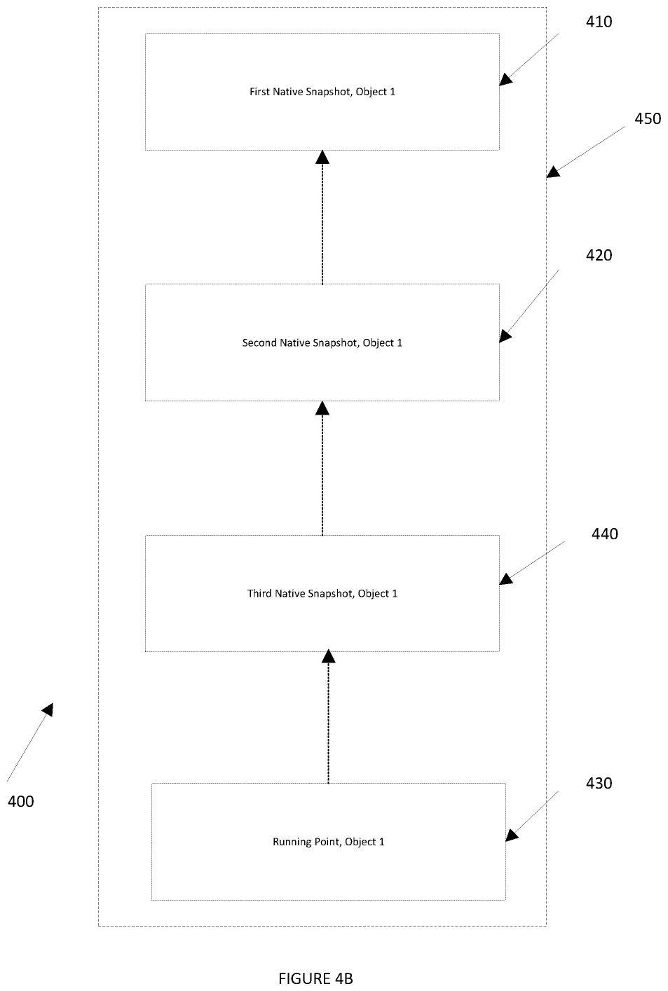

FIG. 4A illustrates a fully native disk chain 400. As shown, a base snapshot disk 410 is a parent of a first child snapshot disk 420. The first child snapshot disk 420 is a parent of a running point virtual disk 430, (also referred to as a “You Are Here” disk). The running point virtual disk 430 is the running point of a VSAN container object 450. The base snapshot disk 420 and the first child snapshot disk 420 are also stored in the VSAN container object 450.

Instead of creating a new delta virtual disk and transferring the running point to a new disk to handle new write operations, subsequent snapshots and write operations are always taken within the same VSAN disk object 450. In this example, only the running point virtual machine disk 430 needs to be opened. With this native snapshot approach, the datablocks corresponding to the base snapshot disk 410 and first child snapshot disk 420 are containerized in the VSAN container object 450 along with the running point disk 430. Thus, the running point will not have to swing between VSAN disk objects.

FIG. 4B illustrates the fully native disk chain 400 after a new native snapshot is generated. When a new write operation is received, the data of the running point disk 430 is copied to a second native snapshot disk 440 contained within the containerized VSAN object 450, and the write operation proceeds to occur at the running point disk 430. Therefore, the running point 430 does not change even as new write operations occur, and the containerized entity 450 does not change. The running point remains constant, which may greatly improve performance by eliminating or reducing swinging.

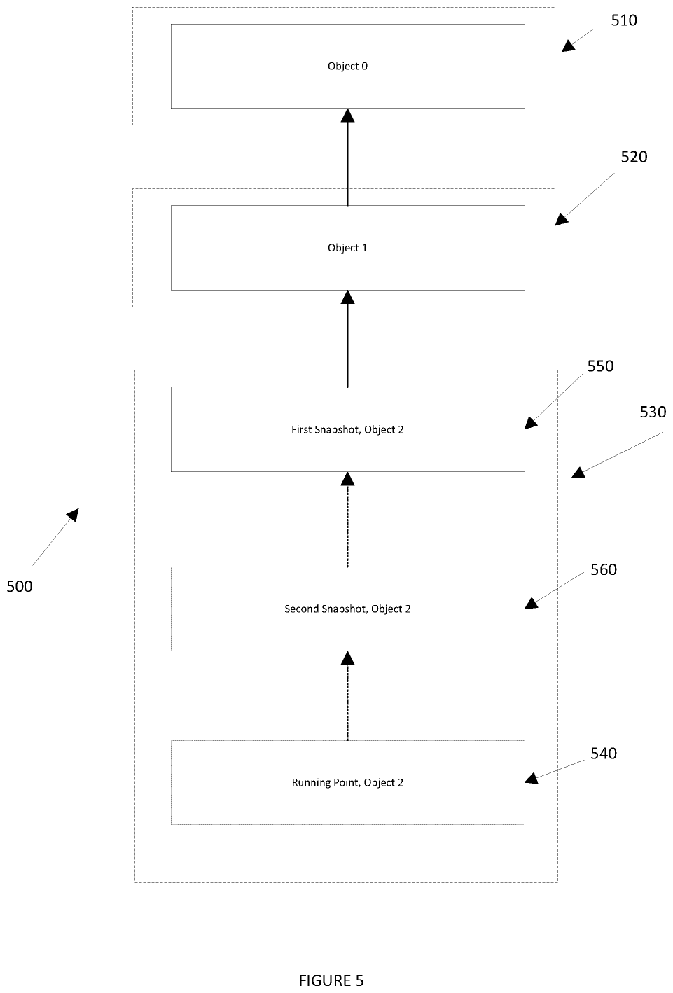

FIG. 5 illustrates a virtual disk chain 500 that has both one or more snapshots in native format and one or more snapshots in redo-log format. For example, once all virtual disk objects have been upgraded to support native snapshot format, subsequent snapshots may be in native snapshot format regardless of the parent format. In various applications, it may be required or desirable that the original redo-log sub disk chain is maintained, and/or that the native approach is used when creating new snapshots for the upgraded virtual disk, and, when possible, for data reversion. The redo-log disk chains and sub disk chains may be preserved while still allowing native snapshot functionality by generating this virtual disk to have both a snapshot in native format and a snapshot in redo-log format.

This may enable backing objects that do not natively support native format snapshots (e.g., backing objects using VSAN on-disk format v1) to have capabilities enabled that are compatible with native format snapshot technology. In particular, metadata about the snapshotted volume is containerized with the snapshots. Maintaining the metadata may improve performance and simplify, for example, traversal of a B+ tree by including indexing information for the data (or pointers) of the B+ tree. When a native snapshot is taken, a B+ tree of the running point disk is copied onto a B+ tree of the newly created snapshot, and subsequent writes occur at a leaf node of the B+ tree of the running point.

In the block diagram of FIG. 5, a virtual disk chain 500 includes a base virtual machine disk 510. The base disk 510 is a redo-log parent disk of a first child disk object 520. The first child disk object 520 is a parent disk of a second child disk object 530. The second child disk object 530 includes a native snapshot parent chain comprising a “You Are Here” (“YAH”) virtual disk 540, a first native snapshot 550, and a second native snapshot 560. The YAH disk accepts new writes as the running point. Therefore, incoming datablocks are written to the second child disk object 530, and the incoming data is containerized with the datablocks of the first native snapshot 550 and the second native snapshot 560.

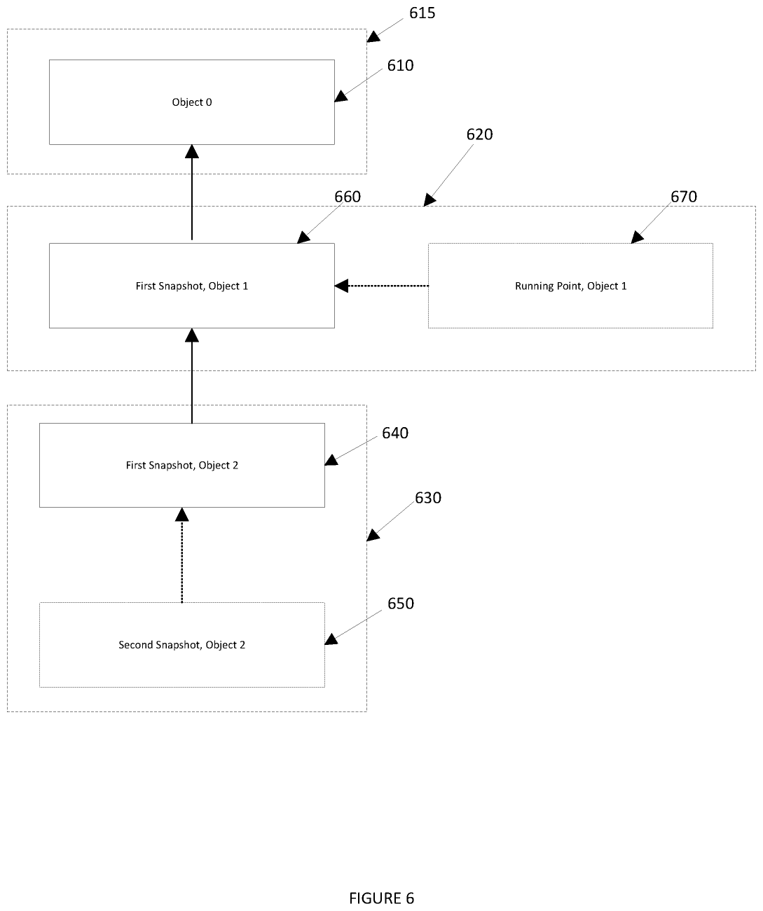

FIG. 6 is a block diagram illustrating a native format snapshot approach for a disk chain 600. As shown, the disk chain 600 is similar to the disk chain 500 and has a base virtual machine disk 610 that is a redo-log parent of a first child disk object 620, and a second child disk object 630 that is a redo-log child of the first child disk object 620. The second child disk object 630 includes a first base redo-log snapshot 640 and a first child native snapshot 650 in a native snapshot chain. The first child disk object 620 includes a second base redo-log snapshot 660 and a running point disk 670.

In the example shown, a native snapshot has been taken on both the first child disk object 620 and the second child disk object 630 (which is a child of the first child disk object 620). This implementation leads to a scenario where, without special handling, two different snapshot entities, 640 and 660, which are both read-only, can become parent and child, leading to possible failure or data loss when a write operation occurs. In the example shown, the two snapshot entities 640 and 660 cannot be compressed and the running point of the virtual disk that is in use will be affected. Here, the native approach has been used to take a native snapshot 650 of the base redo-log snapshot 640. A native snapshot has been taken on the base redo-log snapshot 660, and running point has been maintained at the running point disk 670, which accepts the new write operations. When attempting to restore the virtual disk to the second base redo-log snapshot 660, the parent redo-log snapshot 660 will change based on the write operations that occurred at the running point. Thus, the backing object for the second child disk object may be altered, leading to the possible failure or data loss.

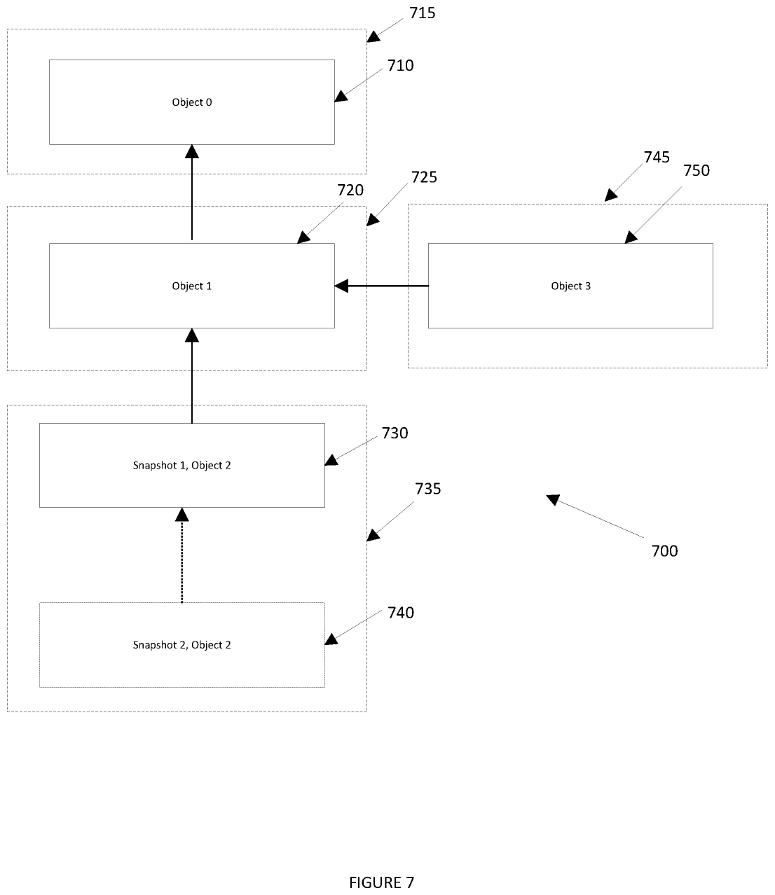

FIG. 7 is a block diagram illustrating a redo-log format snapshot approach for a disk chain 700. Virtual disk chain 700 includes a base virtual machine disk 710 contained in a first disk object 715. The base disk 710 is a redo-log parent disk of a first child disk 720 contained in a second disk object 725. The first child disk object 720 is a parent disk of a native snapshot chain contained in a second child disk object 735. The native snapshot chain of the second child disk object 735 includes a first native snapshot 730 and a second native snapshot 740.

In this example, a redo-log snapshot has been used to generate a snapshot of the first child disk object subsequent to the second native snapshot 740. A new redo-log child delta disk 750 contained in a new delta disk object 745 is generated for the first child disk object 720. The running point is changed to the redo-log child delta disk 750. When using the redo-log approach to revert from the delta disk object 745 to the second disk object 725, the state of the current running point is copied to the disk object 725 and the running point is changed to the disk object. For chain of disk objects where the redo-log approach is used, each disk is on a separate VSAN object, and the running point changes during each reversion operation between disks in the disk chain. This implementation leads to a downgrading of performance as compared to the native approach. As the number of snapshots in the chain increases, the number of VSAN disk objects also increases. The running point also swings between disk objects, and therefore the benefits of a stable running point enabled by native snapshotting are lost.

To prevent failure when traversing both a native parent disk chain and a redo-log parent disk chain from a YAH disk, a virtual root node is created. The virtual root node acts as a logical base or root node of the native disk chain of which the YAH disk is a member. Thus, the native parent chain of the YAH disk may be traversed until the virtual root node is reached. All the disks in the snapshotted virtual disk chain may be traversed, until a base disk (one without a parent) is found. However, the snapshotted entity will never change, as new writes are written to the same virtual machine disk. Therefore, the running point remains fixed and can accepts new writes.

When reverting to a redo-log parent disk object, any write operations occurring after the redo-log snapshot of the redo-log parent disk object should be invalidated. In other words, the running point should be reverted to the redo-log parent without any subsequent changes made to the child disk object. In the case that the child disk object contains a native snapshot disk chain, the tree structure corresponding to the data on the child snapshot disk object may be traversed to the root node prior to or during reversion. The root node maps the data to an empty location (i.e. the root node contains pointers to a memory location with no data). By maintaining or creating a virtual root node for the child disk object, the reversion to the redo-log parent without subsequent write operations is enabled.

In the case where reversion to a grandparent or ancestor of the base disk occurs, the data in the YAH disk may be invalidated when the virtual root node is traversed, the YAH disk may be reparented to the new redo-log parent disk to which the reversion has occurred, and the configuration related to the prior parent deleted. Thus, the running point may be maintained, and native snapshot used for subsequent snapshotting regardless of how many redo-log parent disks are traversed.

A virtual root node may be implemented on a COW data structure as follows: A virtual root node may map each data block to an empty location (i.e. without data). When reverting a native snapshot, the virtual root node maps the data blocks to an empty set of data. If reversion to a redo-log parent occurs, rather than mapping the running point data to a parent snapshot volume, the data is mapped to empty datasets, such that the redo-log parent may treat the child disk as invalid or as an empty or dataless delta disk. In this way, reversion to a redo-log parent of a native snapshot may be performed without the risk of failure, and the running point is maintained during native snapshot creation and during native snapshot reversion to a virtual root node.

In some embodiments, a “thin provision” may be used to save space in memory by only allocating the minimum memory space required. Thus, memory may be allocated only when a write operation occurs for a data block. In some embodiments, metadata about one or more data blocks may be maintained and provisioned for in memory.

FIG. 8 is a diagram illustrating a B+ tree data structure 800 using a COW approach and having a virtual root node 875. The copy-on-write B+ tree data structure 800 may be similar to the data structure 200B of FIG. 2B, except that a virtual root node 875 has been implemented on the copy-on-write B+ tree data structure 800.

As shown in FIG. 8, index node 850 and leaf node 864 are shared by root node 840 of a first B+ tree (e.g., a B+ tree of a parent snapshot) and root node 842 of a second B+ tree (e.g., a B+ tree of a YAH disk) generated from the first B+ tree. This way, the two root nodes 840 and 842 may share the data of the B+ tree without having to duplicate the entire data of the tree. Further, root node 840 may exclusively own leaf node 866, while node 842 of the YAH disk may exclusively own leaf node 868 (where subsequent writes are executed). The virtual root node 875 can serve as the base for any nodes stemming from it, and may also be a base node for a tree data structure of a new node 877. The virtual root node 875 may be a base node for any number of tree structures.

After a snapshot has been created for a data block, metadata on the root node of the B+ tree of the running point is copied to the newly created snapshot volume before new writes are executed at the running point, which remains constant. When a subsequent write operation occurs for new data, a new data block is allocated for the new data to be written. Data block(s) not overwritten by the new write operations are shared by the new snapshot volume and the running point. The shared data is copied, and the new data is written into the newly created snapshot. The newly created snapshot maintains a copy of the B+ tree of the data block prior to the write operation. The B+ tree structures may be considered to have a virtual root node or nodes.

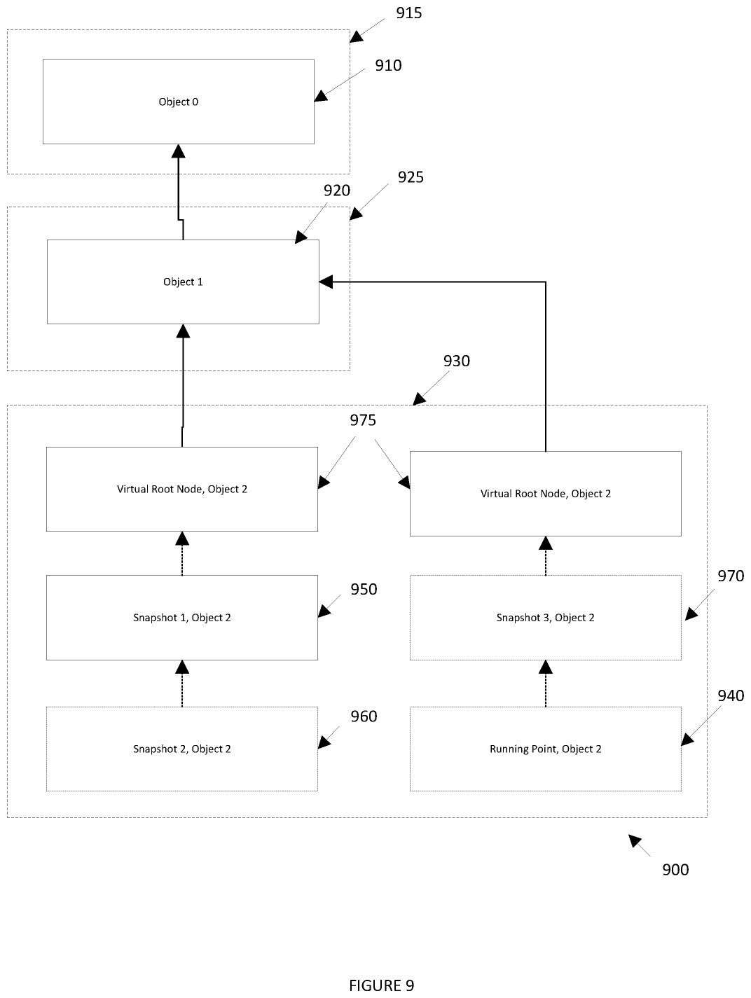

FIG. 9 is a block diagram illustrating a disk chain 900 having both redo-log and native format snapshots. As shown the disk chain 900 includes a base disk 910 contained in a first disk object 915. The base disk 910 is a parent of a first redo-log child disk 920 contained in a first redo-log child disk object 925. A second redo-log child disk object 930 includes a YAH disk 940, a first native snapshot 950, a second native snapshot 960, a third native snapshot 970, and a virtual root node 975. The base disk 910, first redo-log child disk object 920 and second redo-log child disk object 930 form a redo-log parent chain that is similar to that shown in FIG. 3. In the example shown, the virtual root node 975 is generated as a logical base or root node of the data layer for the second redo-log child disk object 930.

According to some embodiments, the disk chain 900 represents the disk chain resulting from performing three native snapshot operations on the disk chain 300. The first native snapshot 950 is made from the second child disk object 930 prior to any subsequent write operations and represents a snapshot of the virtual disk at the point in time in which the first native snapshot 950 is made. Subsequent native snapshots can be made either on previously made redo-log snapshots, such as the second native snapshot 960 or the first native snapshot 920 (and as in FIG. 5), or can be made directly on first the child disk object 920 and written to the second child disk object 1030. Thus, no new redo-log objects are necessary and native capabilities are maximized.

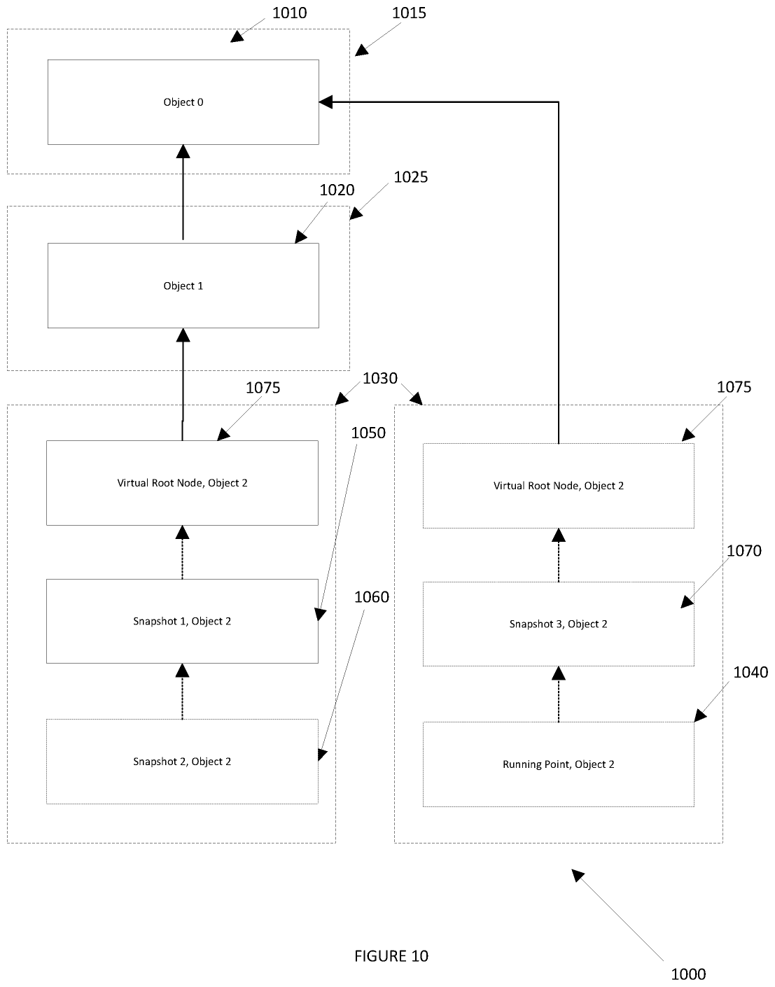

FIG. 10 is a block diagram illustrating a disk chain 1000 having both redo-log and native format snapshots. As shown, the disk chain 1000 includes a base disk 1010 contained in a first disk object 1015 that is a parent of a first redo-log child disk 1020 contained in a first redo-log child disk object 1025. A second redo-log child disk object 1030 includes a YAH disk 1040, a first native snapshot 1050, a second native snapshot 1060, a third native snapshot 1070, and a virtual root node 1075. The virtual root node 1075 is generated as a logical base or root node of the data layer for the second redo-log child disk object 1030. The base disk 1010, first redo-log child disk object 1020 and second redo-log child disk object 1030 form a redo-log parent chain, similar to that shown in FIG. 9, except that in this case, reversion to the base disk 1110 has occurred subsequent to the second native snapshot 1060.

In the example shown in FIG. 10, the third native snapshot 1070 is a native snapshot of the second redo-log child disk object 1030 after the first native snapshot 1050 and the second native snapshot 1060 were taken, but prior to the third native snapshot 1070 being taken. Notably, the YAH disk 1040 of the second child disk object 1030 remains as the constant running point. In various embodiments, the second redo-log child disk object 1030 may be reparented to the base disk 1010 during a snapshot creation or reversion operation.

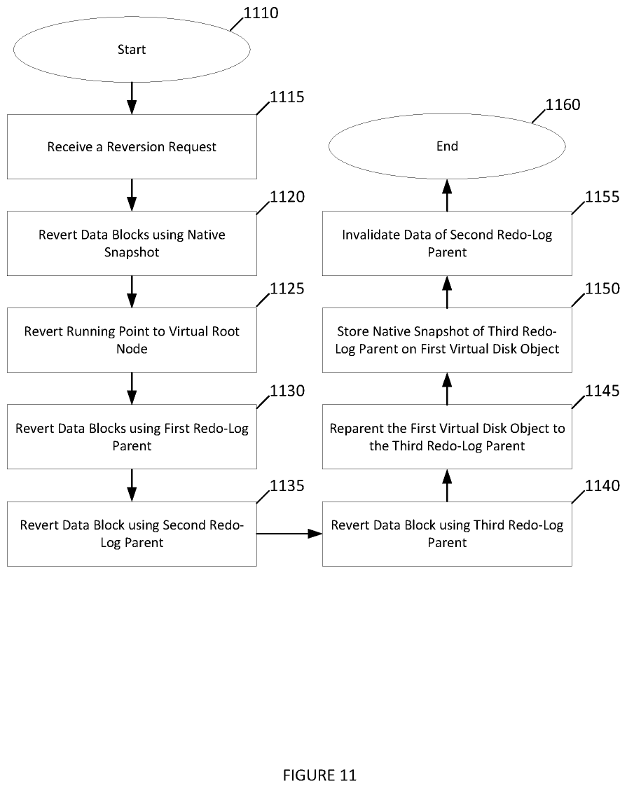

FIG. 11 is a flowchart illustrating a sample workflow 1100 for reversion of a disk chain having redo-log format snapshots and native-format snapshots. Workflow 1100 can begin at starting block 1110 from which the workflow 1100 proceeds to stage 1115 where a reversion request for running point disk of a first virtual machine disk object having one or more native format snapshots and one or more redo-log format snapshot ancestors is received.

From stage 1115 where the reversion request is received, the workflow 1100 may proceed to stage 1120 where the one or more native format snapshot may be used to revert data blocks of the running point disk. For example, where data blocks have been changed since the creation of the native snapshots, the data blocks may be read from a COW data structure (such as a COW B+ tree structure) of the native snapshots and copied to the running point disk. In various embodiments, a plurality of native format snapshots may be used to revert the data of the virtual machine disk. The plurality of native format snapshots may all be stored on the same disk object, and each child may copy a B+ tree of its immediate parent, such that the entire data structure is maintained.

From stage 1120 where the native format snapshots may be used to revert data blocks of the running point disk, the workflow 1100 may proceed to stage 1125 where the running point disk may be reverted to a virtual root node of the native format snapshots. For example, the running point may be reverted to an existing virtual root node, or, also for example, a new virtual root node may be generated for a native format snapshot.

From stage 1125 where the running point may be reverted to a virtual root node, the workflow 1100 may proceed to stage 1130 where the data of the running point disk may be reverted using a first redo-log parent snapshot stored on the first virtual machine disk object.

From stage 1130 where the data of the running point disk may be reverted using a first redo-log parent snapshot stored on the first virtual machine disk object, the workflow 1100 may proceed to stage 1135 where the data of the running point disk may be reverted using second redo-log parent stored on a second virtual machine disk object that is a redo-log parent of the first virtual machine disk object.

From stage 1135 where the data of the running point disk may be reverted using a second redo-log parent snapshot stored on the second virtual machine disk object, the workflow 1100 may proceed to stage 1140 where the data of the running point disk may be reverted using third redo-log parent stored on a third virtual machine disk object that is a redo-log parent of the second virtual machine disk object.

From stage 1140 where the data of the running point disk may be reverted using third redo-log parent stored on a third virtual machine disk object, the workflow 1100 may proceed to stage 1145 where the first virtual disk object is reparented to the third redo-log virtual machine disk object.

From stage 1145 where the first virtual disk object is reparented to the third redo-log virtual machine disk object, the workflow 1100 may proceed to stage 1150 where a native snapshot of the third virtual machine disk object may be stored on the first virtual machine disk object.

From stage 1150 where a native snapshot of the third virtual machine disk object may be stored on the first virtual machine disk object, the workflow 1100 may proceed to stage 1155 where the data of the second redo-log parent is invalidated. From stage 1155 where the data of the second redo-log parent disk of the second virtual disk object is invalidated, the workflow 1100 may proceed to block 1160 where the workflow ends.

Techniques described herein enable native snapshot functionality on a redo-log snapshot disk chain in such a way that maximizes the use of native snapshot while still preserving the redo-log disk chain. By generating a virtual disk container having a YAH disk, a virtual root node, and one or more native snapshots corresponding to subsequent write operations a constant running point is maintained and failure, data loss, and downgrading of performance are prevented. Although a B+ tree data structure is referenced herein with respect to certain embodiments, it will be appreciated that aspects disclosed herein may be applicable for various data structures and approaches, including, but not limited to COW techniques such as copy-on-first-write or redirect-on-write approaches.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for implementing native snapshotting for a snapshot, the method comprising:
receiving a first snapshot disk of a parent disk, the first snapshot disk including first snapshot data;
generating a first native snapshot of the first snapshot disk, the first native snapshot having second snapshot data in a first native data structure;
generating a second native snapshot of the parent disk, the second native snapshot having third snapshot data in a second native data structure; and
storing the first snapshot disk, the first native snapshot, and the second native snapshot in a virtual disk container, wherein:
the first snapshot data is copied into the first native data structure; and
the second snapshot data is copied into the second native data structure.

2. The method of claim 1, further comprising transferring a running point of the parent disk to the virtual disk container.

3. The method of claim 1, further comprising storing metadata of the first snapshot disk, the first native snapshot, and the second native snapshot in the virtual disk container.

4. The method of claim 1, further comprising storing metadata of the parent disk in the virtual disk container.

5. The method of claim 1, further comprising generating a virtual root node for the virtual disk container.

6. The method of claim 1, wherein the first snapshot data is copied into the first native data structure in a first copy-on-write data structure.

7. The method of claim 6, wherein the second snapshot data is copied into the second native data structure in a second copy-on-write data structure.

8. The method of claim 6, wherein the first copy-on-write data structure is a first copy-on-write B+ tree.

9. The method of claim 8, wherein:
the second snapshot data is copied into the second native data structure in a second copy-on-write data structure,
the second copy-on-write data structure is a second copy-on-write B+ tree, and
copying the second snapshot data into the second native data structure comprises copying at least a portion of the first copy-on-write B+ tree into the second copy-on-write B+ tree.

10. The method of claim 8, further comprising generating a virtual root node for the first copy-on-write B+ tree

11. The method of claim 10, wherein the virtual root node comprises a thin provision mapping.

12. The method of claim 1, further comprising performing a plurality of additional native snapshots.

13. The method of claim 1, wherein the first snapshot data includes data associated with a write operation.

14. The method of claim 1, wherein the second snapshot data and the third snapshot data include data associated with copy operations.

15. A non-transitory computer-readable medium comprising instructions that, when executed by one or more processors of a computing system, cause the computing system to perform operations for restoring at least one data block from one or more snapshots, the operations comprising:
performing a revert operation on a first virtual disk container comprising a snapshot having a native parent and a redo-log parent;
if the revert operation is a native parent revert operation, accessing the native parent of the snapshot on the first virtual disk container; and
if the revert operation is a redo-log parent revert operation, traversing a portion of a redo-log parent chain on a second virtual disk container that is the redo-log parent of the first virtual disk container.

16. The non-transitory computer-readable medium of claim 15, wherein the revert operation is a first revert operation and is a native parent revert operation, and the operations further comprise performing a second revert operation that is a redo-log parent revert operation.

17. The non-transitory computer-readable medium of claim 15, wherein the operations further comprise: if the revert operation is a redo-log parent revert operation, accessing a virtual root node of the first virtual disk container.

18. A system comprising:
one or more processors; and
at least one memory, the one or more processors and the at least one memory configured to cause the system to:
receive a first snapshot disk of a parent disk, the first snapshot disk including write operation data;
generate a first native snapshot of the first snapshot disk;
generate a second native snapshot of the parent disk; and
store the first snapshot disk, the first native snapshot, and the second native snapshot in a virtual disk container.

19. The system of claim 18, wherein the one or more processors and the at least one memory is further configured to cause the system to generate a virtual root node for the virtual disk container.

20. The system of claim 18, wherein the first native snapshot and the second native snapshot include copy operation data.
